(19) United States
(12) Patent Application Publication
(10) Pub. No.: US 2016/0207600 A1
(43) Pub. Date: Jul. 21, 2016

(54) Hydro-compressed gas powered marine engine, marine vessels using such engine and method

(71) Applicant: Kurt Paul Grossman, Newport Beach, CA (US)

(72) Inventor: Kurt Paul Grossman, Newport Beach, CA (US)

(21) Appl. No.: 14/987,603

(22) Filed: Jan. 4, 2016

Related U.S. Application Data
(63) Continuation of application No. PCT/US2014/045635, filed on Jul. 8, 2014.
(60) Provisional application No. 61/843,824, filed on Jul. 8, 2013.

(51) Int. Cl. B63H 11/02; F03B 7/00

(52) U.S. Cl. CPC B63H 11/02; F03B 7/003

(57) ABSTRACT

A marine vessel is propelled through water using a hydro-compress gas powered engine including a chamber having a hydropower motor in an upper section and a compressed gas motor in a lower section. In a first cycle of the engine water is introduced into the hydropower motor that driving a drives a crankshaft using the kinetic energy of falling water. Concurrently a portion of a compressed gas stored in a tank is introduced into the compressed gas motor. The compressed gas is stored in a tank at a predetermined potential energy much greater than the kinetic energy of the falling water. A portion of the compressed gas introduced into the compressed gas motor has an amount of potential energy greater than the kinetic energy of the falling water. Compressed gas pushes water from the compressed gas motor the equal in mass to a predetermined mass of water in a gas-water lock. The potential energy of the compressed gas is greater than the usable kinetic energy of the falling water and sufficiently in excess so that in the second cycle and cycles thereafter the potential energy in the tank is restored to its initial potential energy.

### RELATED PATENT APPLICATIONS & INCORPORATION BY REFERENCE

This utility application is a continuation application that claims the benefit under 35 USC §120 of International Application No. PCT/US2014/045635, entitled “HYDRO-COMPRESSED GAS POWERED MARINE ENGINE, MARINE VESSELS USING SUCH ENGINE AND METHOD,” filed Jul. 8, 2014, which claims the benefit under 35 USC §119(e) of U.S. Provisional Patent Application No. 61/843,824, entitled “Hydropower Submerged Propulsion System,” filed Jul. 8, 2013, a copy is attached as appendix A. These related applications are incorporated herein by reference and made a part of this application, and. If any conflict arises between the disclosure of the invention in this PCT application and that in the related provisional application, the disclosure in this utility application shall govern. Moreover, any and all U. S. patents, U. S. patent applications, and other documents, hard copy or electronic, cited or referred to in this application are incorporated herein by reference and made a part of this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

### BACKGROUND

There is a continuing effort to design an engine that uses a low cost fuel in the most efficient way possible. My engine uses the kinetic energy of falling water and the potential energy of compressed gas to run my engine efficiently by recovering and reusing this recovered energy. This engine is especially useful in marine vessels, but it has other application and could be anchored in a body of water near an electric power plant and used to generate electrical energy.

### SUMMARY

My marine engine, marine vessel and method have one or more of the features depicted in the embodiments discussed in the section entitled “DETAILED DESCRIPTION OF SOME ILLUSTRATIVE EMBODIMENTS.” The claims that follow define my marine engine, marine vessel and method, distinguishing them from the prior art; however, without limiting the scope of my marine vessel as expressed by these claims, in general terms, some, but not necessarily all, of their features are:

The weight of water flooding inside of a hull of a marine vessel is a hydropower motor that propels the vessel, for example, a ship or submarine. The water is displaced out the rear of the vessel by compressed gas, for example air, stored in a tank. The compressed gas used to displace the water contains stored potential energy and functions as a compressed gas motor. My engine is a combination of the hydropower motor and the compressed gas motor and it has a first cycle followed immediately by a second cycle. The stored compressed gas energy is recycled to continually repeat the process in the second and subsequent cycles.

Computational fluid dynamics models shows that, when the velocity of water entering a vessel increases, the pressure of the water increases the ambient hydrostatic pressure to reduce the pressure differential between an upper section closest to the water level of a body of water in which a chamber of my engine is submerged. A water jet from a lower section of the chamber is being ejected from the chamber in the body of water at a hydrostatic pressure greater than the pressure entering the upper section. When the vessel moves forward, the pressure of water at the vessel's bow increases and the hydrostatic pressure behind the stern of the ship decreases to further decrease the pressure differential needed to eject a mass of water entering at a higher level and descending to a lower level. Both the Bernoulli Principle and Pascal's Law explain mathematically how the energy efficiency of the motor improves as the ship accelerates because of the decrease in the amount of work required to eject the water from the vessel.

Because a large amount of energy is put into compressing air inside of the vessel that is trapped as stored energy, my engine uses multiple techniques to regenerate power. There are three primary methods for recycling the stored compressed air energy efficiently. The first is to move the compressed air to another area inside of the hull that has similar pressure using a fan. The second is to use an air pressure regulator or air pressure control valve on the inlet of an air compressor. The third is to attach an air motor.

Rather than waste the residual energy, it is stored in one side of a gas-water lock, and use it again. A high efficiency air motor receives air from the this side and flows through an airflow control valve at a predetermined pressure. This energy rotates an air motor that compresses the same air inside the a space in the gas-water lock. A compressor receives the air at an elevated air pressure so there is less work required to compress the air to the initial pressure. The air motor replaces an electrical driven compressor so no electrical energy is consumed. The pressure in one space must be reduced in order to move the piston back to its original position. Sucking air out of a space in the gas-water lock at the same time releases the pressure quickly.

The weight of water is much heavier than air and will flood into the hull rapidly as long as the pressure at a water inlet is lower than the pressure of the water outside of the vessel's hull. The air above an inlet is sucked out to reduce the air pressure in the upper water tank and discharged at a higher pressure in the lower part of the hull to displace the water inside that fell to a lower section of the chamber. The weight of water falling inside the vessel in air constantly introduces new energy into my engine. The careful recovery of compressed air energy stored back into the engine is adequate to overcome all friction, heat loss, or any derivation of entropy. The Laws of Thermodynamics are held in check by constant recirculation and recycling of stored compressed gas that reduces entropy while transferring energy using the hydropower motor.

My engine operates by using the energy of flooding water falling inside the vessel's hull to operate air compressors and machinery that pumps the water below to outside the hull and recycling stored energy in the form of compressed air to keep the system operating at a net positive advantage while propelling the ship forward without the further use of an external energy source after the engine's first cycle of operation at startup.

### DESCRIPTION OF THE DRAWING

Some embodiments of my marine vessel are discussed in detail in connection with the accompanying drawing, which is for illustrative purposes only. This drawing includes the following figures (FIGS.), with like numerals and letters indicating like parts:

FIG. 1 is a schematic illustration of my engine and its method of operation.

FIGS. 1a through 4a are schematic illustrations of one embodiment my engine as it proceeds through the first cycle of its operation where

FIG. 1a depicts the positions of the engine's components at the beginning of the first cycle;

FIG. 2a depicts the positions of the engine's components at the end of the downstroke of the first cycle;

FIG. 3a depicts the positions of the engine's components at the end of the upstroke of the first cycle prior to water being reintroduced into a gas-water lock component;

FIG. 4a depicts the positions of the engine's components at the end of the upstroke of the first cycle prior to water being reintroduced into a gas-water lock component.

FIG. 5 is a schematic illustration of another embodiment my engine employing a pair of lever arms.

FIG. 5a is a schematic plan view of the embodiment depicted in FIG. 5.

FIG. 6 is a schematic illustration of another embodiment my engine employing four lever arms.

FIG. 7 is a schematic illustration of one embodiment of my marine vessel in a static condition and docked in a body of water.

FIG. 8 is a schematic illustration of the embodiment of my marine vessel shown in FIG. 7 moving through a body of water.

FIG. 9 is a schematic illustration of the embodiment of my marine vessel shown in FIG. 7 using several of my engines to turn a crankshaft of the vessel with the engines in a row from bow to stern.

FIG. 10 is a schematic view of the stern of the vessel shown in FIG. 7.

### DETAILED DESCRIPTION OF SOME ILLUSTRATIVE EMBODIMENTS

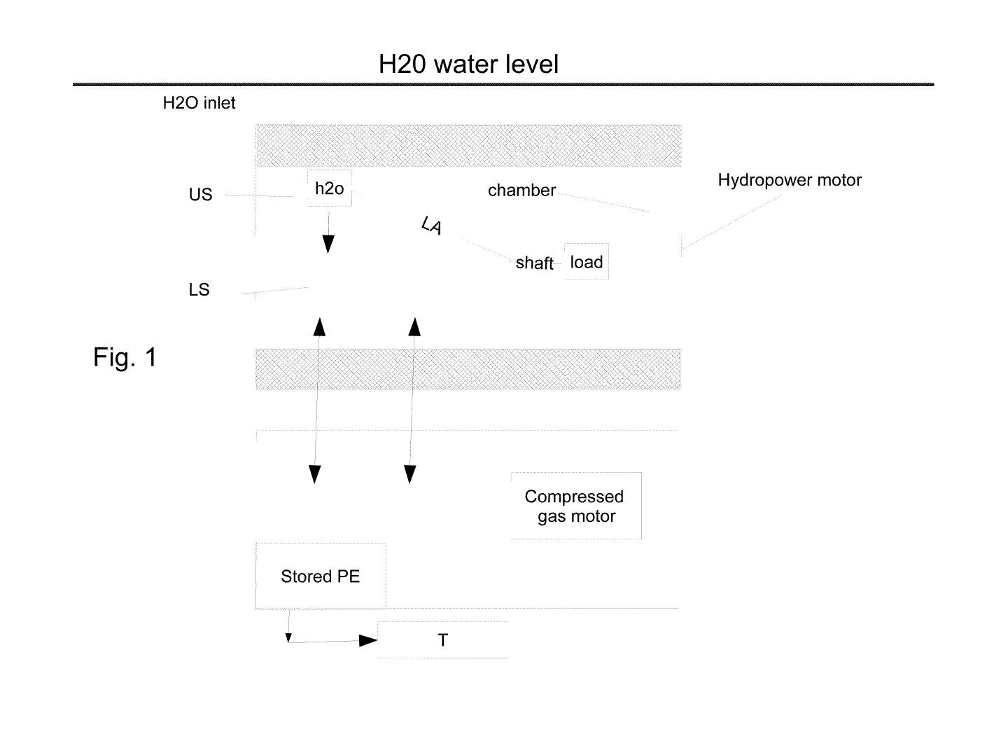

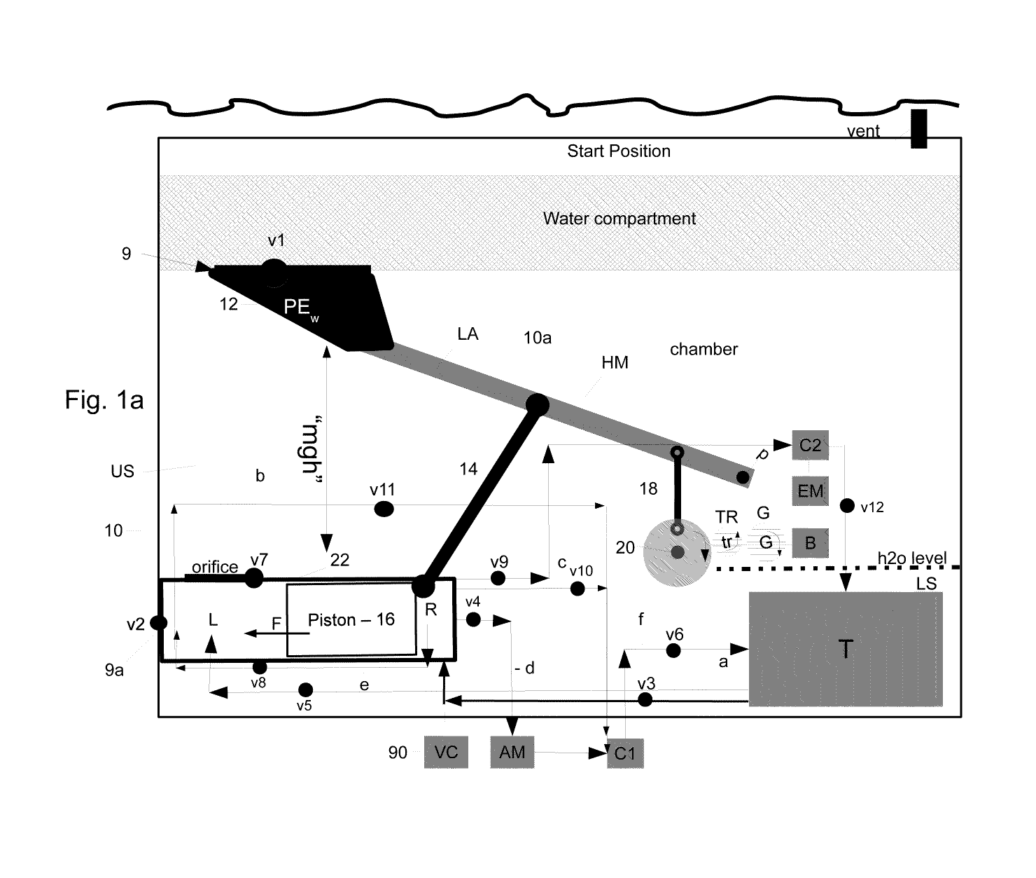

### FIG. 1

FIG. 1 illustrates the main features of my hydro-compressed gas powered marine engine. Two forms of energy are used in my engine: falling water provides kinetic energy KEw and compressed gas G stored in a tank T provides potential energy. The potential energy PE stored in the tank is much greater than the kinetic energy KEw of the falling water generate in any one cycle. The kinetic energy KEw of the falling water alone is insufficient to operate my engine. Consequently, the additional energy provided by the compressed gas is required.

My engine has two cycles: In the first cycle the falling water generates a usable kinetic energy KEw sufficient to do work on a load. An amount of usable potential energy PE is withdrawn as pressurized gas that is in much in excess of that required to do work to expel water from my engine. This change in energy ΔPE lowers the potential energy PE in the tank T to a reduced potential energy PEr.

ΔPE=PE−PEr (1)

The amount of water expelled from my engine during the first and every cycle thereafter is equal to the mass m_{w} of the falling water in each cycle. At the end of the first cycle and prior to beginning the second cycle, the tank T is replenished with compressed gas to return the reduced potential energy PEr of the tank T to its initial potential energy PE level. In other words, an amount of energy is produced during the first cycle that, at a minimum, is equal to the change in potential energy ΔPE. In the second cycle the falling water again generates sufficient usable kinetic energy KEw to do work on a load; however, the energy to replenish the compressed gas energy used in the first cycle is now stored in the tank and is recovered during the second cycle and every cycle thereafter.

The hydropower motor includes a chamber adapted to be filled with a gas, typically air at ambient air pressure, and adapted to be submerged in a body of water. The chamber includes an upper section US including an inlet for water having a valve 1 and a lower section including an outlet for water having a valve 2. As water flows through the inlet into the upper section US and falls into the lower section LS, kinetic energy KEw is generated to turn a drive shaft S operatively connected to a load. The load may be, for example, an electrical generator employed to operate a compressor for providing pressurized gas to the tank. In the lower section LS the mass m_{w} is collected and subsequently expelled through the water outlet by compressed gas stored in the tank T. A compressor recharges the tank T with compressed gas as water is expelled from the engine.

My engine may be view as having two motors: a hydro power motor that typically is 50% efficient in providing usable energy to do work, and a compressed gas motor that is typically 60%-90% efficient in providing usable energy to do work. The amount of usable kinetic energy KE_{w} of the falling water is the same for each cycle. The initial stored potential energy PE in the tank is much greater than the kinetic energy KE_{w} that will be generated by the falling water during any one cycle of the engine. Enough usable potential energy transferred from the tank T is used to expel the water from the chamber, and an excess of this potential energy is stored in the compressed gas motor. The expelled water is equal in mass to the mass m_{w} of the falling water. At least some of the kinetic energy from the falling water being generated is used to restore the tank to its initial potential energy PE.

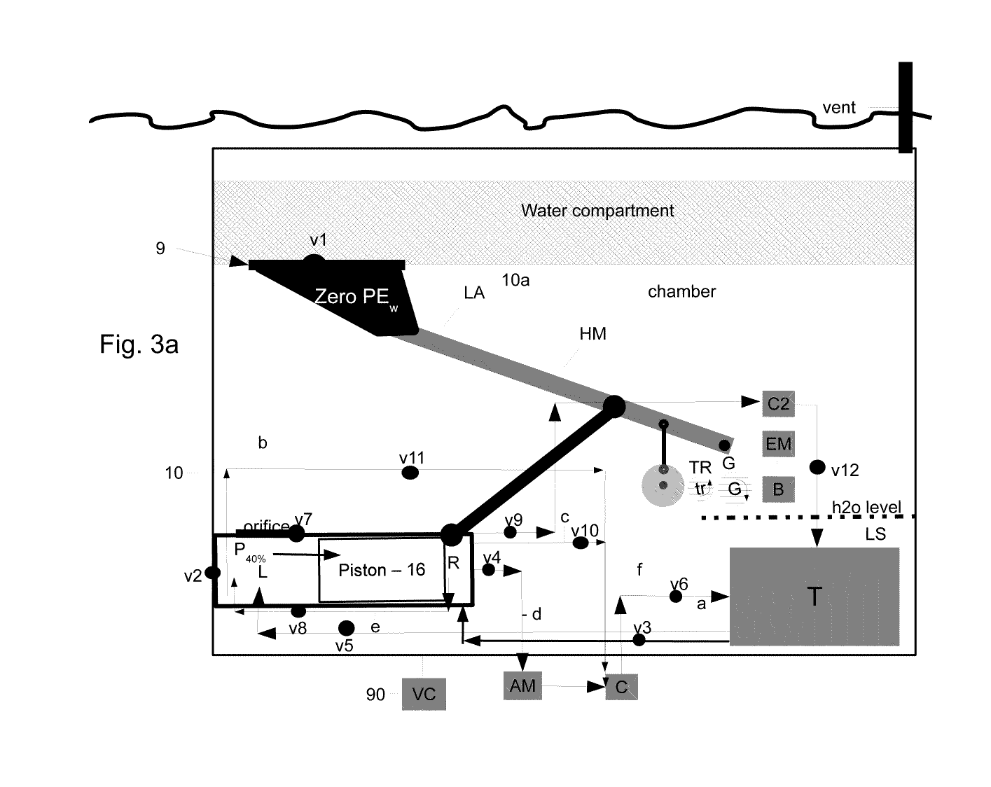

### FIGS. 1a Through 4a

FIGS. 1a-4a illustrate one embodiment of my engine designated by the numeral 10. It includes a chamber 10a submerged in a body of water. There is a water compartment WC above an upper section US of the chamber 10a, a gas-water lock L in a lower section LS, and a hydro-motor HM in the upper section US. The water compartment WC has an open end to allow water from the body of water to fill the compartment. An opening 9 in communication with the upper section US functions as a water inlet to the chamber 10a. This water inlet opening 9 is below the water level of the body of water. There is a pool of water in the lower section LS that only fills this lower section of the chamber 10a, the upper section US being filled with a gas, typically air. The water compartment WC and upper section US are vented to the atmosphere. The opening 9 includes a valve V1 that is opened and closed to control the flow of water from the water compartment.

The gas-water lock L, which is a component of my engine's compressed gas motor, is submerged in the pool of water in the lower section LS below the water level in this lower section. Other components of the compressed gas motor are a storage tank T that initially stores compressed gas having a predetermined initial potential energy (PE), a compressor C1 that compresses gas and feeds the compressed gas to the tank, and an air motor AM that upon actuation operates the compressor C1. The air motor AM and the compressor C1 may be outside of the chamber 10a. Gas lines a through f places these components in communication with each other as depicted in FIG. 1A, and these lines respectively include the valves V3, V4, V5, V6, V8, and V10. There is a valve V7 at an orifice in the gas-water lock L that when open allows water to fill the gas-water lock L. All the valves V1, V2, V3, V4, V5, V6, V7, V8, and V10 are conventional devices that have open and closed states that are changed under the control of a valve control system 90. These valves V1, V2, V3, V4, V5, V6, V7, V8, and V10 may be operated electrically either directly by electrical wiring or remotely. Typically a microprocessor in a control circuit of the valve control system 90 is programmed to open and close the valves to effectuate the operation of my engine as described herein. At startup the valve V1 is closed after first filling a container 12 with the mass and so are all the other valves closed. The container may be configured to empty water from the container as it falls or have a valve that opens upon reaching the lower section. The valve operating system 90 changes the open and closed valve states to regulate the flow of gas through the gas lines a through f in timed relationship to the container 12 falling from the upper section US into the lower section LS to transfer energy from the tank T to the gas-water lock L and expel the water through the outlet opening 9a into the body of water.

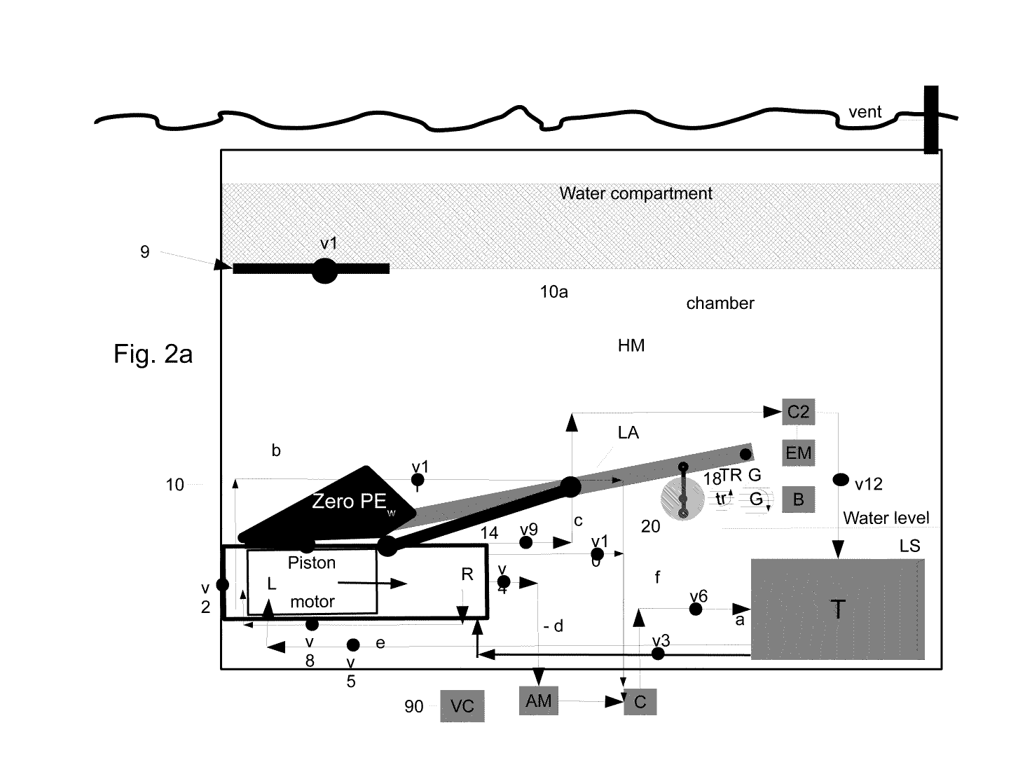

The piston 16 is mounted to move reciprocally within a cylinder 22 and the piston divides the cylinder into a left space L and a right space R. These spaces L and R change in volume as the piston 16 moves between a far right position as shown in FIG. 1A to a far left position as shown in FIG. 2A. At startup the left space L is filled with a water mass m_{w}, the valve V7 being opened momentarily allow water to flow through an orifice in the cylinder 22 to fill the left space. Filling the left space L with water maintains the hydropower motor HM in a startup condition as shown in FIG. 1A, with the container empty of water. Not until the valves V1 and V2 are opened does the hydropower motor HM begin to generate kinetic energy.

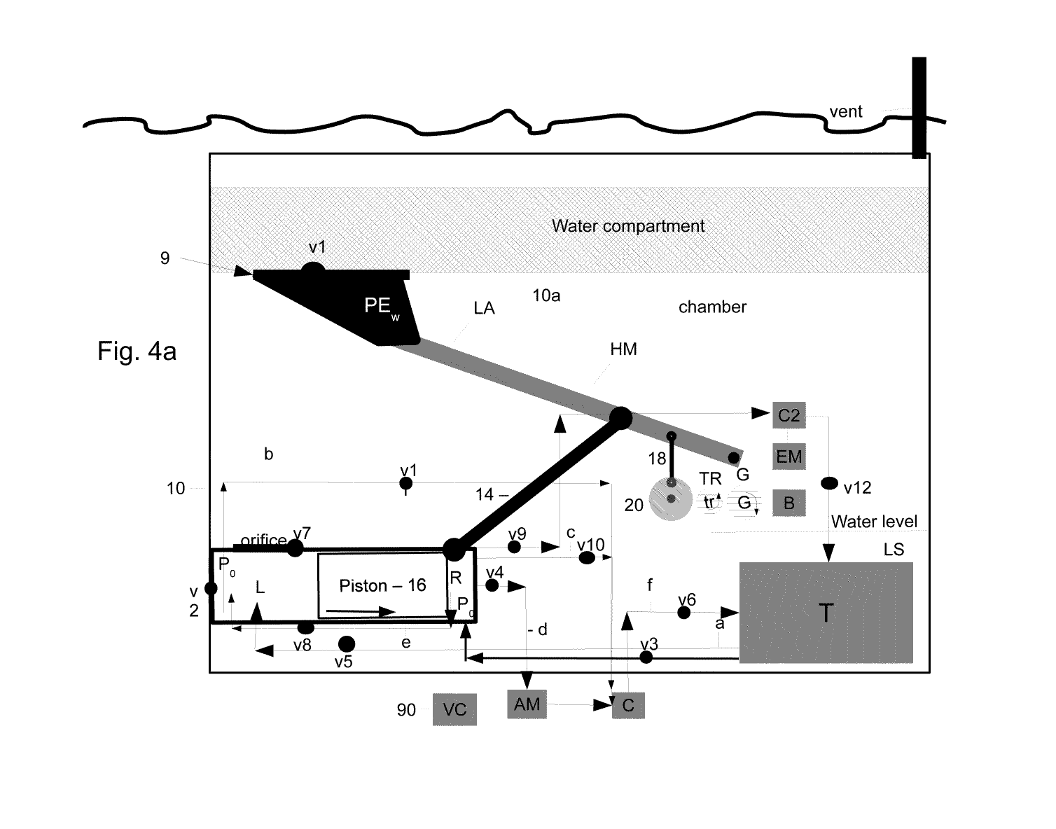

The hydropower motor HM generates kinetic energy (KE_{w}) through the action of the predetermined mass m_{w} of water introduced into the container 12 through the water inlet opening 9 falling from the upper section US downward into the lower section LS due to gravity. In the upper section US above the water level in the lower section LS, a lever arm LA has a connector link 14 attached to the piston 16 and another connector link 18 attached to a drive shaft in the upper section, for example, a crankshaft 20 depicted in FIG. 4B, which may have a fly wheel (not shown) at an end to increase its momentum. The lever arm LA has the container 12 at one end and the arm's other end is mounted rotate about a pivot member P. The piston 16 moves between the right space R of the cylinder 22 and the left space L as the lever arm LA moves downward. The crankshaft 20 is operably connected to a transmission TR, which is operably connected to a generator G. The generator charges a battery B that operates an electric motor EM that drives a compressor C2 that provides compressed air to the tank T. The transmission TR, generator G and electric motor EM arte within the upper section US above the water in the lower section LS.

The engine 10 has a first and second cycle. A portion of the potential energy from the tank T during the first or startup cycle is recovered and used in the second and subsequent cycles. The first cycle starts the operation of the engine 10. First, the water inlet valve V1 is opened so water flows into the container 12, filling it with a mass m_{w} of water. Concurrently, the valve V2 at the water outlet opening 9a is opened and compressed gas from the tank T is fed into the right space R to actuate the piston 16. The crankshaft 20 is driven by kinetic energy as the container 12 falls to rotate the lever arm LA downward, with the water mass m_{w} emptying from the container and flowing into the lower section LS with the falling of the container, This action of the falling container 12 turns the crankshaft through 180 degrees of rotation. Concurrently as the water falls to generate kinetic energy KEw, pressurized gas from the tank T pushes the piston 16 from a right position in the space R to its left side position in space L as shown in FIG. 2A. The energy to do the work W to expel the water mass m_{w} from the air-water lock and out the water outlet comes mainly from the tank T. The amount of energy needed to do this work W to push the piston 16 from its first to the second position over the distance d is equal to the water mass m_{w} times the required force F times the distance d. The force F applied by the piston 16 may be constant over the distance d and is expressed as a pressure P₁. This pressure P₁ must be greater than the pressure P₂ of water at the water outlet in order to push the water mass m_{w} into the body of water upon actuation of the piston 16 to move from the right to the left position as shown in FIG. 2A. Concurrently, kinetic energy from the falling water is transferred through the crankshaft 20 by rotating the transmission TR that operates the generator G to charge the battery B. This stores energy from the first cycle.

With the lever arm LA in the position shown in FIG. 2A, the pressure P1 in the right space R is at the same pressure as the compressed gas in the tank T. Valves V2 and V3 are open and all the other valves are closed. The valve V8 in the line e is opened to place the right space R in communication with the left space L. All the other valves are closed. In this valve condition, gas flows from the right space R into the left space L, reducing the pressure in the right space. This returns the piston 16 to its position shown in FIG. 1A, completing rotation of the crankshaft 20 through a 360 degree turn, and concurrently transferring more energy for storage in the battery B. Then the valve V5 in line a, the valve V11 in line b, first the valve V5 in line 4, and next the valve 10 in line c when the pressure in the right space is reduced to a predetermined pressure. Concurrently, the valve V7 is opened. Opening valve V7 allows water in the lower section LS to now fill the empty left space L with water as air leaves this empty space through line b to flow into the compressor C1. As the piston 16 moves to the right the gas in this space is compressed and first flows through the line d through the open valve V4 into the air electric motor EM that is operably connected the compressor C1. The compressor C1 compresses the gas and feds this compressed gas into the tank T through the line f when the valve V6 is opened.

As gas flows from the tank T into the gas-water lock L, an initial predetermined potential energy PE in the tank is partially depleted, being reduced to the PEr level. During the first cycle, gas is continually introduced into the right space of the gas-water lock until the stored potential energy in the lock L is much more than the amount of usable kinetic energy of the falling water. During the first cycle, a portion of the usable potential energy stored in the gas-water lock L drives the air electric motor EM, which in turn actuates the compressor C1 to recharge the tank T with compressed gas. Another portion of the usable potential energy stored in the gas-water lock L operates the generator G to charge battery B. This battery B now stores recovered energy that is used during the second and subsequent cycles to restore potential energy in the tank T. On the second cycle, the usable KEw of the falling water drives the crankshaft 20. The battery B drives the compressor electric motor EM to actuate the compressor C2, recovering energy. This recovery of stored energy in the gas-water lock restores the diminished energy in the tank T to its initial potential energy PE. The usable kinetic energy of the falling water in the second cycle and in subsequent cycles thereafter is greater than the energy required to restore the potential energy in the tank to its initial potential energy PE and sufficient to turn the crankshaft at the power levels required.

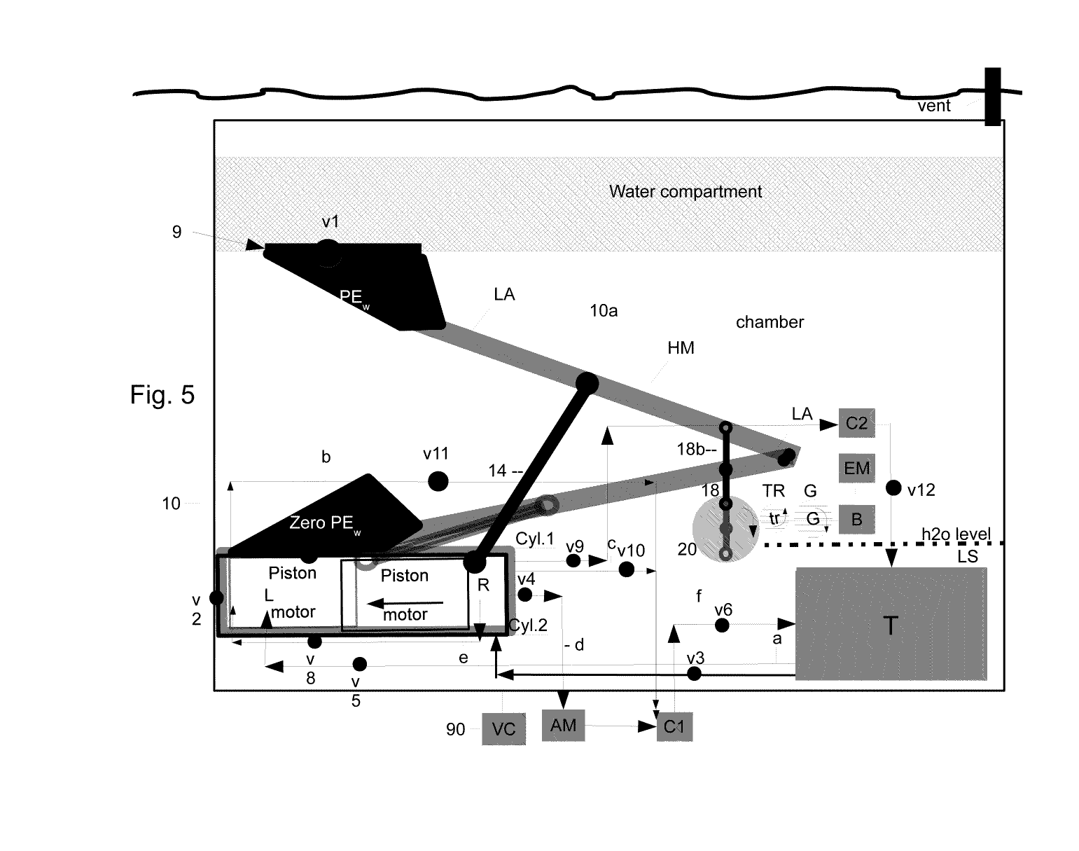

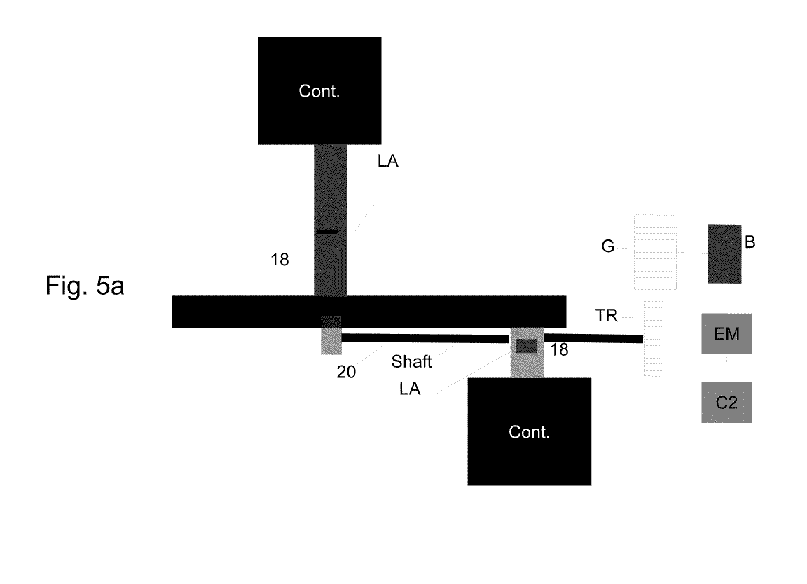

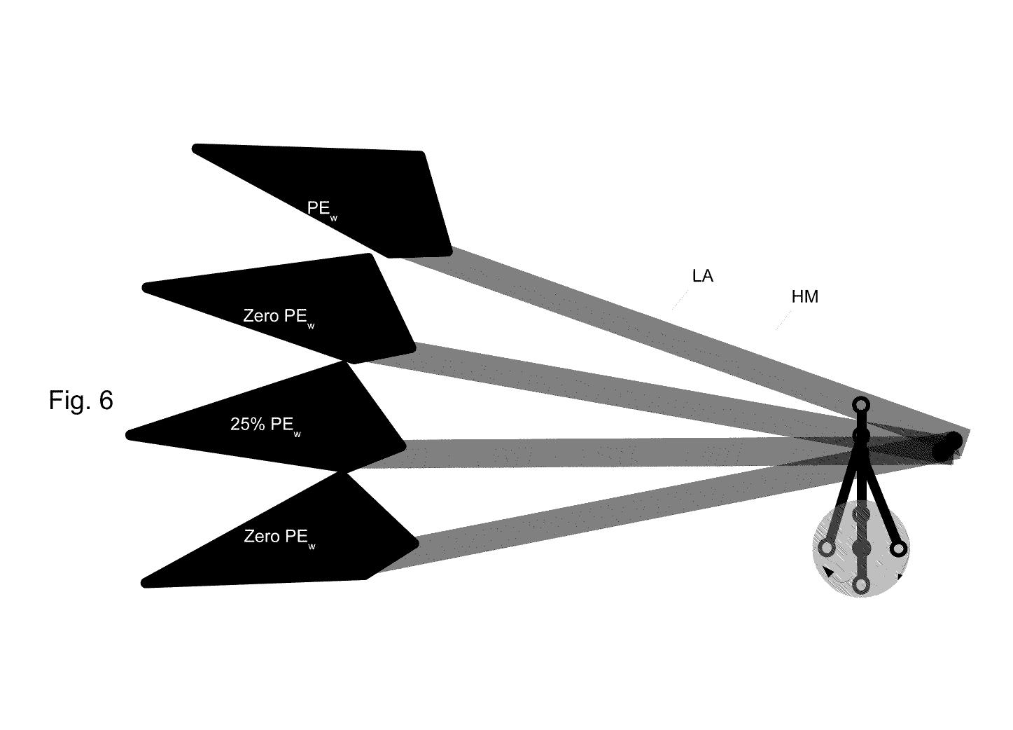

### FIGS. 5, 5a and 6

A pair of lever arms LA1 and LA2 are aligned in a row along the crankshaft 20. These lever arms LA1 and LA2 are independently connected to the crankshaft 20 so that, when the one lever arms is in a raised condition, the other lever arm is in a lowered position. There is a valve V1 and a valve V1′ associated with each lever arm LA1 and LA2 that operate independently, so as one container is filled with water, the empty container on the other arm is emptied. More than a pair of lever arms, for example four lever arms, may be attached to the crankshaft 20 as schematically depicted in FIG. 6. An arrangement of four lever arms is especially advantageous, because the engine operates more smoothly and will provide greater power.

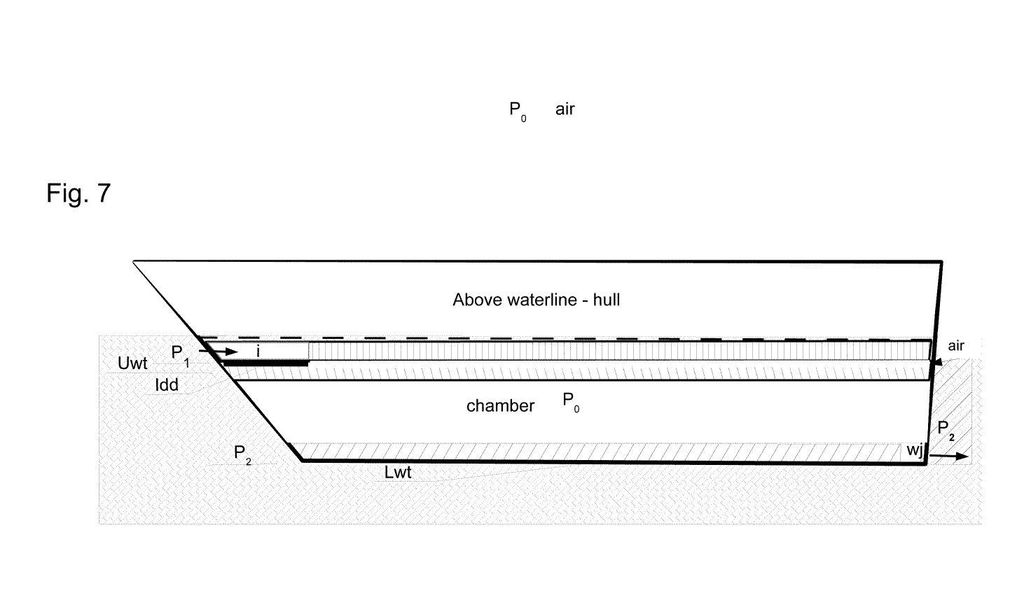

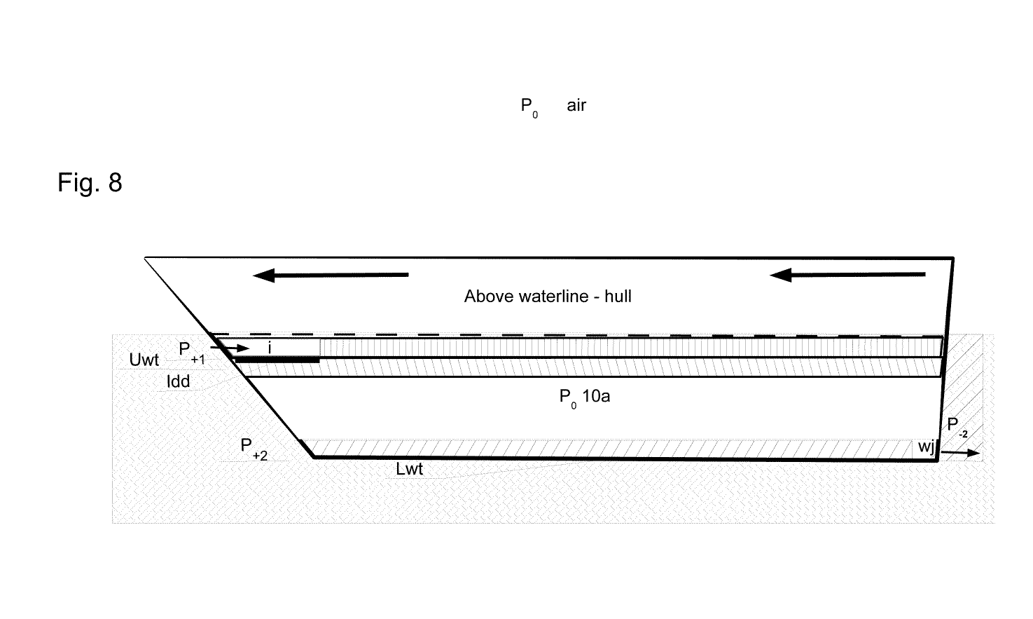

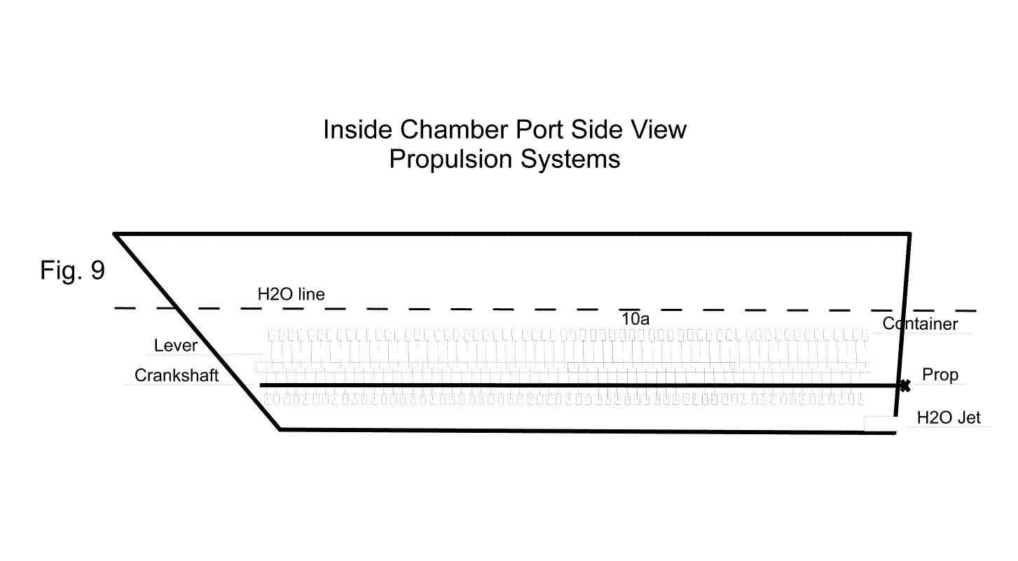

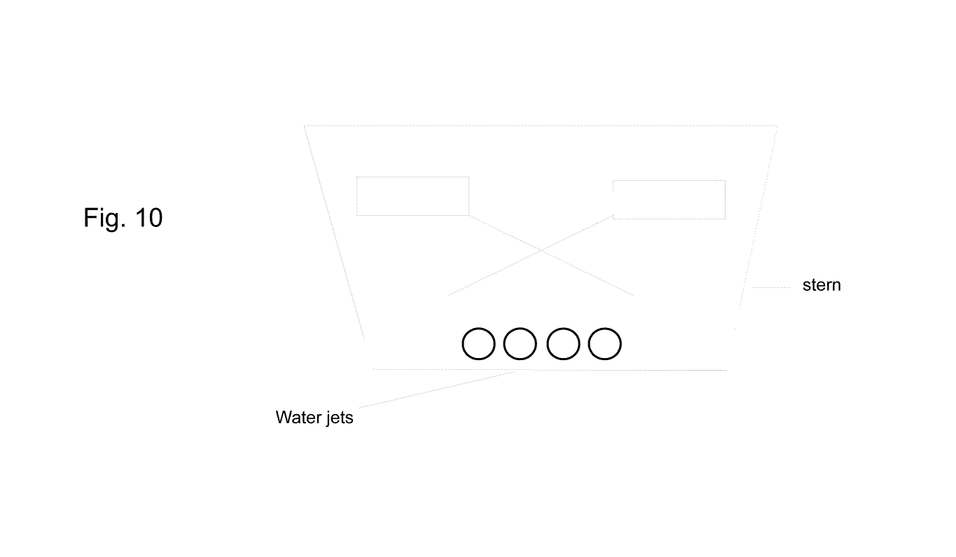

### FIGS. 7 Through 10

As illustrated in FIGS. 7 through 10, several of my engines are located in the hull of a marine vessel 50 whose crankshaft 20 extends from the bow to the stern of the vessel. With the hull floating in the body of water an entrance allows water to flow along a channel extending from bow to stern. Below this channel is the water compartment for the engines, and this water under the control of the valve control system 90 allows water to fill the containers attached to the lever arms of the engines. The chamber of the engines is below the water compartment. The operation of the engines as discussed above turns the crankshaft 20, which at its end extending into the body of water is a propeller. In addition to the propeller, the water is expelled from the vessel as a water jet that is directed rearward from the stern to provide additional propulsion power for the vessel.

For example, at rest, the pressure P1 at the bow at a depth near the water level of the body of water may be 16 psi while pressure P2 at the stern at a greater depth next to the water jet may be 40 psi so that the pressure differential is 24 psi. At a velocity of 20 knots the water pressure P3 at the bow at a depth near the water level of the body of water may be 22 psi while the pressure P2 at the stern at a greater depth next to the water jet may be 34 psi, so that the pressure differential is 12 psi.

### SCOPE OF THE INVENTION

The above presents a description of the best mode I contemplate of carrying out my marine engine, marine vessel and method and of the manner and process of making and using them in such full, clear, concise, and exact terms as to enable a person skilled in the art to make and use. My marine engine, marine vessel and method are, however, susceptible to modifications and alternate constructions from the illustrative embodiments discussed above which are fully equivalent. Consequently, it is not the intention to limit my marine vessel to the particular embodiments disclosed. On the contrary, my intention is to cover all modifications and alternate constructions coming within the spirit and scope of my marine vessel as generally expressed by the following claims, which particularly point out and distinctly claim the subject matter of my invention:

1. A hydro-compressed gas powered engine comprising
a chamber adapted to be filled with a gas and submerged in a body of water and including a drive shaft and an upper section including an inlet and a lower section including an outlet,
a hydro-motor that generates kinetic energy through the action of a predetermined mass of water introduced into a container through the inlet falling from the upper section downward into the lower section due to gravity, said drive shaft being driven by the kinetic energy as the container falls, with the water emptying from the container and flowing into the lower section with the falling of the container,
a gas-water lock in communication with the body of water through the outlet, said gas-water lock having a space of said space being filled with said amount of water equal in mass to said predetermined mass with the action of the falling water,
a storage tank that initially stores compressed gas having a predetermined initial potential energy, a compressor that compresses gas and feeds said compressed gas to the tank, and a compressor motor that upon actuation operates the compressor,
gas lines including valves, said valves having open and closed states placing the gas-water lock and storage tank in communication, and
a valve operating system that changes the open and closed valve states to regulate the flow of gas through said gas lines in timed relationship to the container falling from the upper section into the lower section to transfer energy from the tank to the gas-water lock and expel the water through the outlet into the body of water.

2. The engine of claim 1 where the engine has a first and second cycle and during the first cycle potential energy much greater than the kinetic energy generated by the falling water is recovered and used during the second cycle and any cycle thereafter the recovered energy is transferred to the tank.

3. The engine of claim 2 where the recovered stored energy restores the tank to the predetermined initial potential energy.

4. The engine of claim 2 where the usable kinetic energy of the falling water in the second cycle and in subsequent cycles thereafter is greater than the energy required to restore the potential energy in the tank to said predetermined initial potential energy and sufficient to turn the crankshaft at required power levels.

5. A hydro-compressed gas powered marine engine comprising
a chamber adapted to be filled with a gas and submerged in a body of water and including a drive shaft and an upper section including an inlet and a lower section including an outlet,
a hydro-motor that generates kinetic energy through the action of a predetermined mass of water introduced into a container through the inlet falling from the upper section downward into the lower section due to gravity, said drive shaft being driven by the kinetic energy as the container falls, with the water emptying from the container and flowing into the lower section with the falling of the container,
a gas-water lock in communication with the body of water through the outlet, the gas-water lock including a piston member that divides the gas-water lock into first and second spaces,
said piston member mounted to be moved between a first position remote from the water outlet and a second position proximate the water outlet, with the piston member changing the volumetric capacity of the spaces as said piston moves so that the first space has sufficient volumetric capacity to hold an amount of water equal in mass to said predetermined mass,
a storage tank that initially stores compressed gas having a predetermined initial potential energy (PE), a compressor that compresses gas and feeds said compressed gas to the tank, and a compressor motor that upon actuation operates the compressor,
gas lines including valves, said valves having open and closed states placing the gas-water lock and storage tank in communication, and
a valve operating system that changes the open and closed valve states to regulate the flow of gas through said gas lines in timed relationship to the container falling from the upper section into the lower section to transfer from the tank to the gas-water lock.

6. The engine of claim 5 where the engine has a first and second cycle and during the first cycle potential energy much greater than the kinetic energy generated by the falling water is recovered and used during the second cycle and any cycle thereafter the recovered energy is transferred to the tank.

7. The engine of claim 6 where the recovered stored energy restores the tank to the predetermined initial potential energy.

8. The engine of claim 7 where the usable kinetic energy of the falling water in the second cycle and in subsequent cycles thereafter is greater than the energy required to restore the potential energy in the tank to said predetermined initial potential energy and sufficient to turn the crankshaft at required power levels.

9. A marine vessel that floats in a body of water comprising
a hull that is partially submerged when the vessel is floating in the body of water, said hull including an air chamber that is below a water line when the vessel is floating in the body of water,
within the air chamber, a hydro-compressed gas engine having
a plurality starboard water containers aligned in a row along a starboard side of the hull and a plurality of port water containers aligned in a row along a port side of the hull,
a crankshaft along a centerline of the hull that is mounted to rotate and is mounted with in the hull as said starboard and port water containers raise and as the containers are filled with water and emptied to generate kinetic energy to rotate to rotate the crankshaft,
said starboard and port water containers having an upper water inlet that allows water to flow into individual starboard and port water containers in the raised position,
a water intake structure having an inlet in a bow of the vessel at the water line that feeds water from the body of water into the starboard and port water containers that are in a raised position to expel air from the raised containers and fill said raised containers with water to move said raised containers to the lowered position due to the weight of the water filling the raised tank,
a gas-water lock having an inlet that allows water from water containers in the lowered position to flow into the gas-water lock, said gas-water lock having stored compressed gas at an elevated pressure that upon actuation expels the water from the hull, and
water jet openings below the water line at a stern of the vessel in communication with said gas-water lock from which the expelled water exits the hull to propel the vessel forward in the body of water.

10. A method of propelling a marine vessel through a body of water comprising the steps of
(a) positioning within the vessel a hydro-compress gas powered engine, said engine including a chamber having a hydropower motor in an upper section and a compressed gas motor in a lower section,
(b) in a first cycle of the engine introducing water from the body of water into the hydropower motor, said hydropower motor driving a drive shaft using the kinetic energy of a predetermined mass of water from the body of water flowing into an inlet in the hydropower motor and falling through a gas in the chamber from the upper section into the lower section,
(c) concurrently with the introduction of water into the hydropower motor, introducing a portion of a compressed gas stored in a tank into the compressed gas motor, the compressed gas stored in the tank being at a predetermined potential energy much greater than the kinetic energy of the falling water and said portion of the compressed gas introduced into the compressed gas motor having an amount of potential energy greater than said kinetic energy produced in the first cycle by the falling water,
(d) expelling from the compressed gas motor the stored water equal in mass to said predetermined mass of water, said potential energy of the compressed gas being greater than the usable kinetic energy of the falling water and sufficiently in excess so that in the second cycle and cycles thereafter the potential energy in the tank is restored e to the initial potential energy PE,
(e) directing said mass of expelled water in a direction to move the vessel through the body of water.
